(19) United States
(12) Patent Application Publication
(10) Pub. No.: US 2026/0067877 A1
(43) Pub. Date: Mar. 5, 2026

(54) SINGLE-CARRIER SPARSE CODE MULTIPLE ACCESS

(71) Applicant: Lenovo (United States) Inc., Morrisville, NC (US)

(72) Inventors: Abir Ben Hadj Fredj, Wiesbaden (DE); Ali Ramadan Ali, Kraiburg (DE)

(73) Assignee: Lenovo (United States) Inc., Morrisville, NC (US)

(21) Appl. No.: 18/826,017

(22) Filed: Sep. 5, 2024

(51) Int. Cl. H04W 72/0453; H04W 72/044

(52) U.S. Cl. CPC H04W 72/0453; H04W 72/0466

(57) ABSTRACT

Various aspects of the present disclosure relate to single-carrier sparse code multiple access (SC-SCMA), where multiple user equipment (UE) are multiplexed over one carrier frequency and multi-dimensional codewords are transmitted over multiple time units, e.g., symbols, slots, and so forth. Two or more UEs can spread their associated multi-dimensional codewords over the same time symbols or slots. At the receiver side, frequency domain equalizer (FDE) and a modified multi-UE detection architecture can be used to efficiently detect and decode each UE's data.

### TECHNICAL FIELD

The present disclosure relates to wireless communications, and more specifically to single-carrier sparse code multiple access (SC-SCMA).

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication. The UE receives a configuration for the UE to transmit a first multi-dimensional sparse codeword across a set of multiple time units over a single carrier frequency; transmits the first multi-dimensional sparse codeword across the set of multiple time units over the single carrier frequency.

Additionally or alternatively, the set of multiple time units comprises a set of multiple symbols, a set of multiple time slots, a set of multiple subframes, a set of multiple frames, or a combination thereof. Additionally or alternatively, the first multi-dimensional sparse codeword is determined from a first sparse codebook. Additionally or alternatively, the set of multiple time units are contiguous. Additionally or alternatively, the set of multiple time units are non-contiguous. Additionally or alternatively, the configuration indicates a first antenna of multiple antennas the UE is to use to transmit the first multi-dimensional sparse codeword.

Some implementations of the method and apparatuses described herein may further include a base station for wireless communication. The base station transmits a first configuration for a first UE to transmit a first multi-dimensional sparse codeword across a set of multiple time units over a single carrier frequency; transmits a second configuration for a second UE to transmit a second multi-dimensional sparse codeword across the set of multiple time units over the single carrier frequency; receives, simultaneously, the first multi-dimensional sparse codeword and the second multi-dimensional sparse codeword across the set of multiple time units over the single carrier frequency.

In some implementations of the method and apparatuses described herein, the set of multiple time units comprises a set of multiple symbols, a set of multiple time slots, a set of multiple subframes, a set of multiple frames, or a combination thereof. Additionally or alternatively, the first multi-dimensional sparse codeword is determined from a first sparse codebook, wherein the second multi-dimensional sparse codeword is determined from a second sparse codebook, and wherein the first sparse codebook is different than the second sparse codebook. Additionally or alternatively, the set of multiple time units allocated to the first UE are contiguous. Additionally or alternatively, the set of multiple time units allocated to the first UE are non-contiguous. Additionally or alternatively, the first configuration indicates a first antenna of multiple antennas the first UE is to use to transmit the first multi-dimensional sparse codeword, and wherein the second configuration indicates a second antenna of multiple antennas the second UE is to use to transmit the second multi-dimensional sparse codeword. Additionally or alternatively, the base station detects and associates, using a detector and a frequency domain equalizer (FDE), the first multi-dimensional sparse codeword with the first UE; and detects and associates, using the detector and the FDE, the second multi-dimensional sparse codeword with the second UE. Additionally or alternatively, the detector comprises a common factor graph based multi-UE detector and a parallel UE-specific factor graph-based detector. Additionally or alternatively, the detector could comprise an iterative detection algorithm.

Some implementations of the method and apparatuses described herein may further include a processor for wireless communication. The processor receives a configuration for the processor to transmit a first multi-dimensional sparse codeword across a set of multiple time units over a single carrier frequency; transmits the first multi-dimensional sparse codeword across the set of multiple time units over the single carrier frequency.

In some implementations of the method and apparatuses described herein, the set of multiple time units is available to at least one additional processor for transmission. Additionally or alternatively, the first multi-dimensional sparse codeword is determined from a first sparse codebook.

Some implementations of the method and apparatuses described herein may further include a method performed by a base station, the method comprising: transmitting a first configuration for a first UE to transmit a first multi-dimensional sparse codeword across a set of multiple time units over a single carrier frequency; transmitting a second configuration for a second UE to transmit a second multi-dimensional sparse codeword across the set of multiple time units over the single carrier frequency; and transmitting a second configuration for a second UE to transmit a second multi-dimensional sparse codeword across the set of multiple time units over the single carrier frequency.

In some implementations of the method and apparatuses described herein, the method further comprises: wherein the set of multiple time units comprises a set of multiple symbols, a set of multiple time slots, a set of multiple subframes, a set of multiple frames, or a combination thereof.

### BRIEF DESCRIPTION OF THE DRAWINGS

FIG. 1 illustrates an example of a wireless communications system in accordance with aspects of the present disclosure.

FIG. 2 illustrates an example of a network setup including ambient Internet of things (A-IoT) devices in accordance with aspects of the present disclosure.

FIG. 3 illustrates an example of codeword spreading over multiple resources in accordance with aspects of the present disclosure.

FIG. 4 illustrates an example of single-carrier FDMA (SC-FDMA) in accordance with aspects of the present disclosure.

FIGS. 5 and 6 illustrate examples of SC-SCMA with UEs multiplexed on the same symbols in accordance with aspects of the present disclosure.

FIG. 7 illustrates an example of SC-SCMA where UEs are allocated and multiplexed on the same slots in accordance with aspects of the present disclosure.

FIG. 8 illustrates an example of SC-SCMA combined with multi-UE multiple input multiple output (MU-MIMO) in accordance with aspects of the present disclosure.

FIG. 9 illustrates an example of a factor graph associated with SC-SCMA in accordance with aspects of the present disclosure.

FIG. 10 illustrates an example receiver architecture associated with SC-SCMA in accordance with aspects of the present disclosure.

FIG. 11 illustrates an example of a UE in accordance with aspects of the present disclosure.

FIG. 12 illustrates an example of a processor in accordance with aspects of the present disclosure.

FIG. 13 illustrates an example of a network equipment (NE) in accordance with aspects of the present disclosure.

FIG. 14 illustrates a flowchart of a method performed by a UE in accordance with aspects of the present disclosure.

FIG. 15 illustrates a flowchart of a method performed by an NE in accordance with aspects of the present disclosure.

### DETAILED DESCRIPTION

In some wireless communication systems, network equipment (NE) (e.g., base stations) and/or user equipment (UE) may support non-orthogonal multiple access (NOMA) by using overlapping time and frequency resources to perform wireless communication (e.g., transmit and/or receive control information and/or data). In some cases, supporting non-orthogonal multiple access, such as for uplink (UL) may enhance the throughput and capacity of these wireless communication systems. In some cases, to handle interference caused by using overlapping resources, the NE and/or UE (i.e., the transmitter entity) can apply (e.g., use) schemes such as spreading and interleaving.

NOMA schemes can be divided into two categories, code domain NOMA and power domain NOMA. Sparse code multiple access (SCMA) is one of the code domain NOMA schemes, which merges (e.g., combines) quadrature amplitude modulation (QAM) mapping and spreading and encodes incoming bits into a sparse codeword, which is determined (e.g., drawn, generated, selected) from an associated sparse codebook. However, SCMA schemes are multiplexed over OFDM tones, which induces high peak-to-average-power ratio (PAPR) and is not suitable for certain types of UEs, such as A-IoT devices that are deployed with ultra-low complexity and ultra-low power consumption. As frequency subcarriers are used as resources for SCMA, the scheme can be referred to as multi-carrier SCMA because SCMA is assumed as an alternative to OFDM and OFDM orthogonal frequencies are utilized. Although multi-carrier systems provide advantages, in the receiver entity of the multi-carrier systems there are some challenges, such as high PAPR, which may impact the reliability of wireless communication between the NE and the UE, as well as the performance of the NE and/or UE. Accordingly, SC-SCMA is discussed herein.

This disclosure presents apparatuses, methods and procedures to enable SC-SCMA where multiple UEs are multiplexed over one carrier frequency and multi-dimensional codewords are transmitted by the multiple UEs over multiple time units (e.g., symbols, slots, etc.). Two or more UEs can spread their associated multi-dimensional codewords over the same time symbols or slots. Spreading a multi-dimensional codeword refers to different dimensions of the multi-dimensional codeword being communicated (e.g., transmitted, sent, output) in different time units (e.g., time symbols or slots), and each of two or more UEs can communicate (e.g., transmit, send, output) a dimension of their codeword in a same time unit (e.g., time symbol or slot). At the receiver entity (e.g., the NE), a frequency domain equalizer (FDE) and a modified multi-UE detection architecture can be used to efficiently detect and decode each UE's transmission (e.g., control information and/or data).

In one or more implementations, multiple SCMA layers/UEs are multiplexed over the same carrier frequency using SC-SCMA. Each UE is allocated a different time unit (e.g., symbol, slot or frame), and multiple UEs can be multiplexed over the same time unit. Each UE is assigned (e.g., allocated, configured) a different sparse codebook that allows multi-UE detection at the receiver entity (e.g., the NE). Additionally, SC-SCMA can be combined with MU-MIMO and spatial multiplexing can be used to further enhance the capacity of the NE (e.g., an amount UEs that the NE can serve). Additionally, SC-SCMA's corresponding receiver architecture is described where the multi-UE (e.g., multi-user) detection algorithm is a detector (for example, a factor graph-based algorithm) along with a frequency domain equalizer. Common factor graph-based algorithms and parallel UE-specific factor graph-based algorithms are examples of algorithms that can be used to resolve impairments caused by frequency selective channels.

Multicarrier NOMA has been considered where SCMA codewords are multiplexed over OFDM tones and spread over multiple orthogonal subcarriers. The multicarrier NOMA is not adapted to UEs with low energy consumption and low complexity as well as systems that require low-PAPR. In contrast, the techniques discussed herein describe SC-SCMA where multiple UEs are transmitting over a same carrier frequency and SCMA codewords are spread over multiple time slots. SC-FDMA, which is a single carrier transmission technique that allows lower PAPR compared to OFDM, only allows orthogonal access. In SC-FDMA, multiple access among UEs is made possible by assigning different UEs different sets of non-overlapping Fourier coefficients (i.e., sub-carriers). This is achieved at the transmitter entity (e.g., a UE or NE) by inserting (prior to inverse discrete Fourier transform (IDFT)) silent Fourier coefficients (at positions assigned to other transmitter entities, e.g., UEs or NEs), and removing them at the receiver entity (e.g., an NE or UE) after the discrete Fourier transform (DFT). In contrast, the techniques discussed herein describe single carrier SCMA where multiple UEs are transmitting over the same carrier frequency, which provides capacity gains as well as lower PAPR.

Aspects of the present disclosure are described in the context of a wireless communications system.

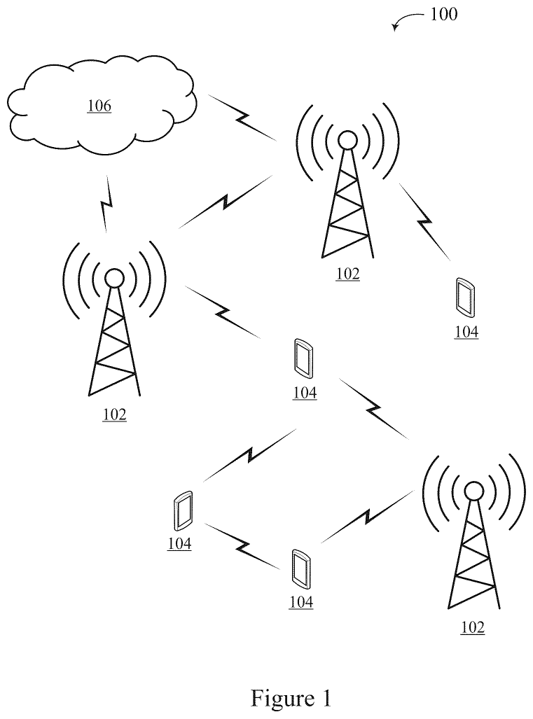

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The techniques discussed herein enable SC-SCMA where multiple UEs 104 share the same single carrier frequency and the same time units, and are allocated different sparse codebooks having different multi-dimensional codewords. These sparse codebooks allow superposition of UE 104 transmissions and hence allow SCMA systems to support more connected ultra-low complexity and ultra-low power consumption devices with reduced PAPR levels. The multi-dimensional codewords of each UE (which may also be referred to as a user) can be spread over multiple time units, such as symbols, time slots or frames. At the receiver (e.g., NE 102), the received superposed signals can be detected using FDE (frequency domain equalizer) and a modified multi-UE detection architecture. It should be noted that in one or more implementations, the UEs 104 transmit the multi-dimensional codewords at the same or similar power levels.

Reference is made herein to a set of multiple time units. A set of multiple time units refers to a group of two or more time units, such as two or more symbols, two or more time slots, two or more subframes, two or more frames, or a combination thereof. Reference is also made herein to sparse codewords being transmitted by multiple UEs simultaneously or received from multiple UEs simultaneously. Multiple UEs transmitting simultaneously refers to the multiple UEs transmitting data (e.g., codeword or dimension of a codeword) at the same time, such that the data transmitted by the multiple UEs is superposed. Receiving from multiple UEs simultaneously refers to receiving data (e.g., codeword or dimension of a codeword) from the multiple UEs at the same time, such that the data received from the multiple UEs is superposed.

Reference is also made herein to receiving or transmitting data, information, symbols, and so forth. It is to be appreciated that other terms may be used interchangeably with receiving or transmitting, such as communicating, outputting, forwarding, retrieving, obtaining, and so forth.

A-IoT is taken into consideration, including use cases, traffic scenarios, device constraints of ambient power enabled IoT, potential service requirements, and key performance indicators (KPIs).

Considering the limited size and complexity affordable by practical applications for battery-less devices with no energy storage capability or devices with limited energy storage that do not need to be replaced or recharged manually, the output power of the energy harvester typically ranges from 1 μW to a few hundreds of μW. Existing cellular devices may not work well with energy harvesting due to their peak power consumption of higher than 10 mW.

Different deployment topologies can be used for A-IoT devices. In one deployment topology, which may be referred to as Topology 1, the A-IoT device directly and bidirectionally communicates with a base station. In another deployment topology, which may be referred to as Topology 2, the A-IoT device communicates bidirectionally with an intermediate node between the device and the base station. The intermediate node can be a relay, Integrated Access and Backhaul (IAB) node, UE, repeater, etc., which can support A-IoT. In another deployment topology, which may be referred to as Topology 3, the A-IoT device transmits data/signaling to a base station and receives data/signaling from an assisting node; or the A-IoT device receives data/signaling from a base station and transmits data/signaling to the assisting node. In this topology, the assisting node can be a relay, IAB, UE, repeater, etc. which can support A-IoT. In another deployment topology, which may be referred to as Topology 4, the A-IoT device communicates bidirectionally with a UE. A large set of use cases for ambient power enabled IoT has been considered and representative deployment scenarios for studies, each covering more use cases and topologies are being considered.

Using bi-/multi-static links can enable positioning and will remove the challenges associated with full duplexing self-interference for a monostatic A-IoT illuminator and reader device.

Three A-IoT device types are considered. One device type, which may be referred to as Device A, is a passive device. Device A refers to pure battery-less devices with no energy storage capability at all, no independent signal generation/amplification (e.g., capable of only backscattering), and completely dependent on the availability of an external source of energy. ˜1 μW peak power consumption has energy storage, initial sampling frequency offset (SFO) up to 10^{X} ppm. Another device type, which may be referred to as Device B, is a semi-passive device. Device B refers to devices with limited energy storage capability that do not need to be replaced or recharged manually, no independent signal generation but backscattering potentially with reflection gain. Another device type, which may be referred to as Device C, is an Active device. Device C refers to an actively transmitting device with limited energy storage capabilities based on ambient energy sources. E.g., ≤a few hundred μW peak power consumption, has energy storage, initial SFO up to 10 ppm, both downlink (DL) and/or UL amplification in the device.

The design target pillars of low data rate, ultra-low cost, ultra-low-power devices at small form factor but with improved range compared to Radio Frequency Identification (RFID) and with positioning enabled at relaxed accuracy is taken into consideration. The following targets of device complexity and power consumption are taken into consideration. With respect to device complexity, for Device A, the complexity target is to be comparable to ultrahigh frequency (UHF) RFID ISO18000-6C (EPC C1G2); for Device B, the target is such that Device A complexity<Device B complexity<Device C complexity; and for Device C, the complexity target is to be orders-of-magnitude lower than NB-IoT. With respect to power consumption, for Device A, the power consumption target during transmitting/receiving is ≤1 μW; for Device B, the target during transmitting/receiving is such that: Device A power consumption<<Device B power consumption<Device C power consumption, or Device A power consumption<Device B power consumption<Device C power consumption; for Device C, the device power consumption is ≤1 mW.

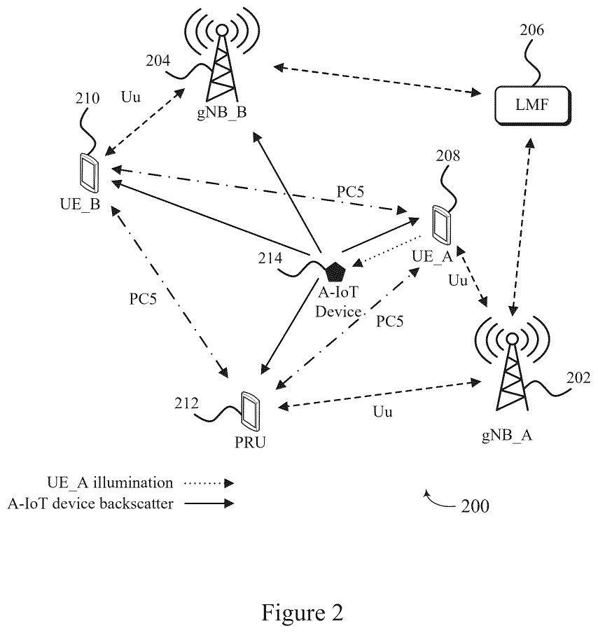

FIG. 2 illustrates an example of a network setup 200 including A-IoT devices in accordance with aspects of the present disclosure. The network setup 200 includes a base station 202 and a base station 204, a location management function (LMF) 206, a UE 208, a UE 210, a positioning reference unit (PRU) 212, and an A-IoT device 214. The base station 202 can communicate with the LMF 206, and with the UE 208 and the PRU 212 over a Uu interface. The base station 204 can communicate with the LMF 206, and with the UE 210 over a Uu interface. The UE 208, the UE 210, and the PRU 212 can communicate with one another over a PC5 interface. The A-IoT device 214 can backscatter a signal (which may be referred to as an illumination or activation signal) to one or more other devices, such as the base station 204, the UE 208, the UE 210, or the PRU 212.

Returning to FIG. 1, NOMA is distinct from orthogonal multiple access (OMA), which allocates UEs separately in orthogonal dimensions such as time and frequency, as seen in time-division multiple access (TDMA) and frequency division multiple access (FDMA). NOMA, conversely, combines UEs within the same time-frequency resources using the power or code domain. According to power-domain NOMA, superposition coding (SC) is applied at the transmitter, and successive interference cancellation (SIC) is performed at the receivers. This approach, also referred to as SC-SIC, is motivated by its ability to achieve the capacity region of the single-input single-output (SISO) Gaussian broadcast channel. This capacity region is larger than what OMA (e.g., TDMA) can achieve when UEs have varying channel strengths. However, when UEs have similar channel strengths, OMA based on TDMA is sufficient to attain the capacity region. Another technique is spatial division multiple access (SDMA), which superimposes UEs on the same time-frequency resources and differentiates each UE along the spatial domain using multi-UE linear precoding. Another technique may be referred to as multi-antenna NOMA, which consists of ordering UEs based on their effective scalar channel strengths (post-precoding) and enforces the receivers to decode messages in a successive manner. This results in one receiver decoding all messages based on a single-antenna degraded channel.

An overview of the advantages and disadvantages of single-antenna NOMA broadcast channel, SDMA, and multi-antenna NOMA broadcast channel are discussed below.

Advantages of single-antenna NOMA broadcast channel, include overload handling, which refers to the capability to cope with an overloaded capacity regime in a spectrally efficient manner, where multiple UEs have different channel characteristics including varying RSRPs/path losses on the same time-frequency resource. Disadvantages of single-antenna NOMA broadcast channel include scalability. In a K-UE SISO broadcast channel, the UE with the best channel employs SIC to decode the messages of all other K−1 co-scheduled UEs before accessing its own intended data stream. While SIC for a small number of layers is manageable in practical terms, the complexity and the risk of error propagation become notably challenging as the number of UEs increases.

Advantages of SDMA include spatial multiplexing gain. SDMA takes advantage of the spatial multiplexing gain based on the knowledge of perfect channel state information (CSI) and lower receiver complexity. Disadvantages of SDMA include overload handling, UE grouping, and imperfect CSI. With respect to overload handling, SDMA performs well in an underloaded capacity regime, however the performance drops in an overloaded regime and requires more Tx antennas at the gNB than UEs served in a cell to manage multi-UE interference. One approach is to schedule groups of UEs over orthogonal resources and perform linear precoding in each group. This approach can increase overall latency.

With respect to UE grouping, the effectiveness of SDMA depends on the degree of UE channel orthogonality and their channel conditions, e.g., signal strengths, necessitating the scheduler to group UEs with moderately similar channel strengths. If an exhaustive search is conducted, the scheduler's complexity can rise significantly, but less complex (though not optimal) scheduling and UE-pairing algorithms may also be used. With respect to imperfect CSI, the optimality of SDMA diminishes when dealing with imperfect CSI. The challenge in designing multi-UE low power (MU-LP) in imperfect CSI at the transmitter (CSIT) scenarios typically involves adapting a framework originally designed for perfect CSIT, rather than developing a framework tailored from the outset for imperfect CSIT. This approach has resulted in significant performance degradation for MU-LP when imperfect CSIT is present.

Advantages of multi-antenna NOMA broadcast channel include overload handling. Similar to the SISO case, multi-antenna NOMA broadcast channel has the capability to cope with an overloaded capacity regime in a spectrally efficient manner, where multiple UEs have different channel characteristics including varying RSRPs/path losses on the same time-frequency resource. Disadvantages of multi-antenna NOMA broadcast channel include degree of freedom (DoF) loss, higher complexity, and imperfect CSI. With respect to DoF loss, UEs are ordered on channel strengths to achieve the capacity region which limits the spatial multiplexing gains offered by multi-antenna systems.

With respect to higher complexity, utilizing multi-antenna NOMA introduces higher complexity at both the transmitter and the receivers. Unlike single-antenna NOMA, multi-antenna NOMA uses a multi-layer SIC process at the receivers. Furthermore, since multi-antenna NOMA is vector-based as opposed to scalar-based, it lacks a natural order for arranging UE channels. Consequently, the scheduler at the transmitter jointly optimizes three aspects including precoders, UE groups, and decoding orders. For example, when applying NOMA with “SC-SIC” to a three-UE multiple-input single-output (MISO) broadcast channel, the optimization involves three precoders (one for each UE) and consideration of six possible decoding orders. As the number of UEs increases, the potential decoding orders grow exponentially. With respect to imperfect CSI, similar to SDMA, multi-antenna NOMA broadcast channel is also vulnerable to imperfect CSI since the original design is based on the perfect CSI assumption.

Low density spreading (LDS) is a special case of SCMA. LDS as a form of multi-carrier CDMA (MC-CDMA) is used for multiplexing different layers of data. As opposed to SCMA with multi-dimensional codewords, LDS uses repetitions of the same (QAM) symbol on layer-specific nonzero position in time or frequency. As an example, in LDS-orthogonal frequency division multiplexing (LDS-OFDM) a constellation point is repeated (with some possible phase rotations) over nonzero frequency tones of an LDS block. The shaping gain and coding gain of multi-dimensional constellations is one of the advantages of SCMA over LDS. The gain is potentially high for higher order modulations where the repetition coding of LDS shows a large loss and poor performance.

An SCMA encoder and an SCMA decoder are used with SCMA. SCMA is an evolution of LDS. To better understand SCMA, an overview of LDS is briefly described. In contrast to OMA schemes such as orthogonal frequency-division multiplexing (OFDM) where each UE has a dedicated resource (subcarrier), LDS allows multiple UEs to simultaneously share the same resource. In the case of LDS, repetition code is used, and each UE transmits the same QAM symbol over different resources. The LDS scheme can be represented by a bipartite graph (known as factor graph) which can be associated with a signature matrix. A graph is composed of vertices (or nodes) and edges. Two nodes are connected with an edge when there is some relationship between them. Different types of graphs are used to model problems in areas such as computer science, biology, physics, etc. One graph for modelling communication and signal processing problems is called a bipartite graph. In this graph, total nodes can be divided in two sets and no two nodes within a set are connected to each other. A factor graph is an undirected bipartite graph in which one set of nodes is called variable nodes (VNs) and the other is called function nodes (FNs). An edge is connected between a variable node and a function node if that particular variable is an argument of that function. A factor graph shows how a global function can be represented in terms of simpler local functions (denoted by FNs) and can also help in computing marginal distribution with respect to single variable using sum-product algorithm (SPA). SCMA follows the same design concepts of LDS, however one difference is that SCMA allows the use of multi-dimensional constellations instead of repetition coding which results in a more than 1 dB shaping gain. By contrast to LDS, QAM mapping and spreading are merged together in SCMA and therefore several incoming bits (of a certain UE) can be directly mapped to a sparse complex vector (codeword) which is determined (e.g., drawn, generated, selected) from its associated sparse codebook. Thanks to the sparsity of the codebooks, the multi-UE signals can be efficiently detected and recovered at the receiver with the aid of MPA whose error rate performance approaches that of maximum a posteriori (MAP) detector.

The SCMA factor graph has three parameters which are: overloading factor (dₒᵥₑᵣ), which refers to a number of UEs/number of subcarriers, multiplexing factor (d_{c}), which refers to a number of symbols multiplexed on each subcarrier, and spreading factor (dᵥ), which refers to a number of subcarriers each symbol is spread over. In general, there are two major research lines associated with SCMA: 1) codebook (CB) design and 2) multi-UE detection (MUD).

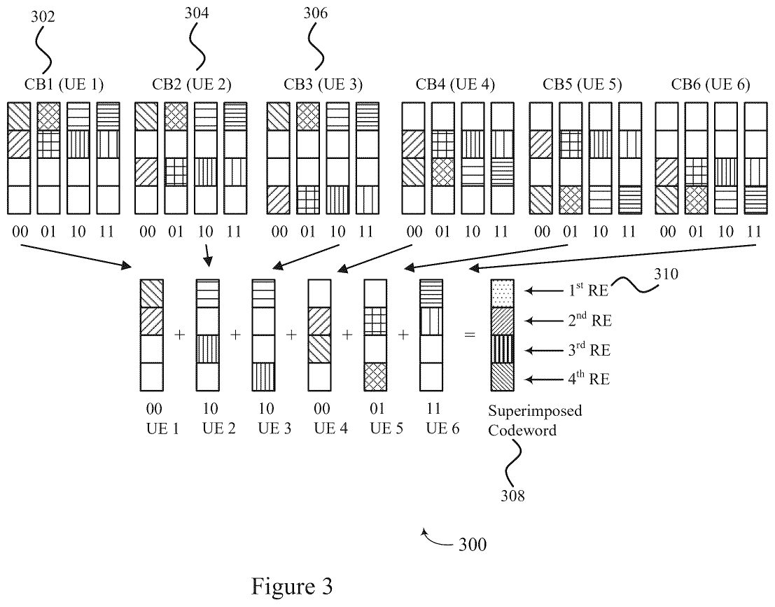

FIG. 3 illustrates an example 300 of codeword spreading over multiple resources in accordance with aspects of the present disclosure. The example 300 illustrates SCMA's codewords spreading over multiple resources.

In the example 300, there are J UEs that transmit uplink data to a base station K resource elements, where J=6 and K=4 in this example. Each UE is configured with a different CB. Different codewords from the CBs are selected, and a superposed codeword is generated. For example, a codeword from the CB 302 for UE 1, a codeword from the CB 304 for UE 2, and a codeword from the CB 306 for UE 3 are selected. A superimposed codeword 308 is generated that includes the codeword from the CB 302 for UE 1, the codeword from the CB 304 for UE 2, and the codeword from the CB 306 for UE 3 in a first resource element (RE) 310 of the superimposed codeword 308.

In the example 300, J UEs transmit uplink data to a base station using K resource elements (e.g., time, frequency-slots). The SCMA system is assumed to be perfectly synchronous. In SCMA, the data or input bits of UE are mapped to a complex codeword using the SCMA encoder. For instance, if UE j wants to transmit bⱼ bits, the encoder will map these bⱼ bits to a codeword mⱼ selected from a pre-defined codebook CBⱼ as shown below:

$${m}_{j} = {CB}_{j} ( {b}_{j} )$$

where mⱼ∈ [symbol] ⊂ [symbol] , where [symbol] denotes the set of codewords of the j^{th} UE.

An SCMA encoder has J layers and there is a specific CB dedicated to each UE. Assuming one layer per UE and in the following “UE” and “layer” are used interchangeably. The performance gain of SCMA over other NOMA schemes is strongly dependent on well-designed sparse codebooks. The codebook of each UE has its own sparsity pattern and can be written as a matrix of size K×M, where M denotes the number of codewords (e.g., columns of a CB matrix) allotted to a UE. In a CB, each column vector (e.g., codeword) is sparse consisting of dᵥ non-zero elements at certain fixed resources elements (REs) pertinent to a specific UE. Albeit numerous SCMA codebooks have been proposed, the optimal codebook design remains an open challenge. The current designs are mostly sub-optimal which are based on a multi-stage approach. For the j-th UE, multidimensional codebooks can be expressed as:

$${CB}_{j} = {V}_{j} {Δ}_{j} {A}_{MC}^{′}$$

where Vⱼ∈ [symbol] denotes the binary mapping matrix,

$${A}_{MC}^{′}$$

denotes the multi-dimensional mother constellation and Δⱼ refers to the constellation operator for the j-th UE, respectively. The mapping matrix is selected in such a way that each UE has active transmissions over a few fixed REs only.

Unitary rotations may be applied to a mother constellation to increase power variation among different UEs in order to reinforce the “near-far effect” for suppression or mitigation of multi-UE interference as well as to enhance the constellation shaping gain. Once the mother constellation is designed, layer-specific operations are applied to generate multiple CBs for different UEs. These operations may include phase rotation, complex conjugate, layer power offset, and dimensional permutation.

With respect to the SCMA decoder, consider a symbol-synchronous uplink SCMA system where J UEs communicate over K REs. Let mⱼ be the transmitted codeword of the j-th UE, where mⱼ∈ [symbol] has cardinality M=2^{b} with b denoting the number of bits per codeword. Let us consider a (4,6) SCMA system with M=4, i.e., each codebook has 4 codewords that are mapped to two binary bits. For an uplink SCMA system, let hⱼ=[h₁ⱼ, . . . h_{KJ}] be the effective channel fading coefficient for the j-th UE, where hₖⱼ denotes the channel fading coefficient at the kth RE for the jth UE. Let mⱼ=[C_{1,J}, . . . , C_{K,J}] be the transmitted codeword of the j-th UE, where C_{k,J} is the codeword element transmitted by the j-th UE on the k-th RE. The received signal at the base station is:

$$y = {\sum }_{j = 1}^{J} diag ( {h}_{j} ) {m}_{j} + n \qquad ( 1 )$$

where n∈ [symbol] is the noise vector, each element of which can be modelled as complex Gaussian distribution [symbol] (0, σ²). Due to the sparse nature of SCMA codebooks, non-zero values from d_{c} out of J number of UEs overlap over each RE and also each UE data is transmitted on dᵥ<K resource elements.

At the receiver, the objective of an optimal detector is to minimize the probability of error (P(e)) for the transmitted bit sequence x, e.g., to minimize the mismatch between transmitted bits (x) and estimated bits (\dot{x}):

$$min ( P ( e ) ) = min ( P ( x \neq \dot{x} ) )$$

MPA is an algorithm to conduct inference from graphical models by passing belief messages between the nodes. In SCMA systems, each VN denotes one data layer, and each function node (FN) denotes the likelihood function at the resource element (RE). Therefore, the total number of VNs is equal to the total number of layers/UEs and the total FNs equals the total REs present.

Suppose the transmitted bits are c=[c₁; c₂; . . . ; c_{N}] and received bits are y=[y₁; y₂; . . . ; y_{N}], then the aim is to compute the a posteriori probability (APP) of bit cᵢ, i.e., P(cᵢ=0/y): Using Bayes' rule, the APP ratio with regard to cᵢ can be converted into likelihood ratio as follows:

$$\frac{P ( {c}_{i} = 0 / y )}{P ( {c}_{i} = 1 / y )} = \frac{f ( y / {c}_{i} = 0 )}{f ( y / {c}_{i} = 1 )}$$

Taking natural logarithm, the Log-likelihood ratio (LLR) of cᵢ below is obtained:

$$LLR ( {c}_{i} ) = log ( \frac{f ( y / {c}_{i} = 0 )}{f ( y / {c}_{i} = 1 )} )$$

If LLR(cᵢ)<0, then cᵢ=1 is decoded otherwise 0.

Message passing in a factor graph using SPA is an iterative process if the factor graph has cycles (closed loops) present in it. In every iteration, there are two steps. In Step 1, a belief message is passed from a variable node (VN) to a function node (FN) and in Step 2, the message is passed from an FN to a VN, respectively. These two steps are discussed in detail as follows. In Step 1, suppose there is a VN j₁ which has connections with 3 FNs with indices k₁; k₂; k₃. To pass a message from VN j₁ to FN k₂, firstly VN j₁ multiplies all the messages received from its neighboring nodes except FN k₂ (i.e., k₁ and k₃) and then transfers the output to FN k₂.

$${n}_{{j}_{1} \to {k}_{2}} = {n}_{{k}_{1} \to {j}_{1}} {n}_{{k}_{3} \to {j}_{1}}$$

where, nⱼ_{₁}_{→k}_{₂} indicates the belief message from VN j₁ to FN k₂. The outgoing message from a VN is in the form of P(cᵢ=0/y) or APP ratio or likelihood ratio.

In Step 2, a belief message is passed from an FN to a VN. Consider an FN k₁ which has three neighboring VNs (j₁; j₂; j₃). To send a belief message from FN k₁ to VN j₂, FN k₁ first collects all the messages from its neighboring nodes except for VN j₂. These received messages are multiplied with the local function ƒₖ_{₁}(j₁, j₂, j₃) associated with FN k₁ and then the resulting function is marginalized with respect to VN j₂. After marginalization, the resulting message to be sent to VN j₂ can be expressed as follows:

$${n}_{{k}_{1} \to {j}_{2}} = {\sum }_{∼ {j}_{2}}^{.} ( {f}_{{k}_{1}} ( {j}_{1} , {j}_{2} , {j}_{3} ) {n}_{{j}_{1} \to {k}_{1}} {n}_{{j}_{3} \to {k}_{1}} )$$

where ƒₖ_{₁}(j₁, j₂, j₃) indicates the local function of FN k₁ and message nₖ_{₁}_{→j}_{₂} indicates P(k₁ function is satisfied|messages received at FN k₁), respectively. Similarly, if a belief message needs to be passed from FN k₁ to VN j₃, then the belief message from the VNs j₁ and j₂ (all VNs except the one to which message needs to be passed) is considered as extrinsic information.

In SCMA, UE information bits are converted into sparse multidimensional codewords using a 3D codebook. As indicated above, SCMA technology allows for an increase in the spectral efficiency, number of UE connections, and bit error rate (BER) performance compared to other existing access methods. Another technology capable of increasing the spectral efficiency of communication system is multiple input multiple output (MIMO). MIMO involves the use of multiple antennas at the transmitter and/or receiver. Systems with the combined use of MIMO and SCMA technologies can improve the performance of single-antenna SCMA systems. By using MIMO as spatial multiplexing, it is possible to increase the transmission rate in MIMO-SCMA systems several times. The MIMO-SCMA system can be obtained by extending equation (1) above to T transmitting and R receiving antennas. Hence, the received signal at each antenna (i) can be expressed as:

$${Y}^{( i )} = {\sum }_{j = 1}^{T} {H}^{( i ) , ( j )} {X}^{( j )} + {N}^{( i )}$$

where H is the channel matrix of dimension KR×KT and N is an additive white Gaussian noise of dimension KR×1.

With respect to single-carrier transmission techniques, SC-FDMA is a frequency-division multiple access scheme. Originally known as Carrier Interferometry, it is also called linearly precoded OFDMA (LP-OFDMA). Like other multiple access schemes (TDMA, FDMA, CDMA, OFDMA), SC-FDMA deals with the assignment of multiple UEs to a shared communication resource. SC-FDMA can be interpreted as a linearly precoded OFDMA scheme, in the sense that it has an additional DFT processing step preceding the conventional OFDMA processing.

SC-FDMA has is as an alternative to OFDMA, especially in the uplink communications where lower PAPR greatly benefits the mobile terminal in terms of transmit power efficiency and reduced cost of the power amplifier. This is where SC-FDMA gets its name from: it's an OFDM signal that mimics the characteristics of a single-carrier QAM signal. SC-FDMA has been adopted as the uplink multiple access scheme in 3GPP Long Term Evolution (LTE), or Evolved Universal Terrestrial Radio Access UTRA (E-UTRA). The performance of SC-FDMA in relation to OFDMA has been the subject of various studies. Although the performance gap is small, SC-FDMA's advantage of low PAPR makes it desirable for uplink wireless transmission in mobile communication systems, where transmitter power efficiency is of paramount importance.

The transmission processing of SC-FDMA is very similar to that of OFDMA. For each UE, the sequence of bits transmitted is mapped to a complex constellation of symbols (binary phase-shift keying (BPSK), quadrature phase shift keying (QPSK), or M-QAM). Then different transmitters (UEs) are assigned different Fourier coefficients. This assignment is carried out in the mapping and de-mapping blocks. The receiver side includes one de-mapping block, one IDFT block, and one detection block for each UE signal to be received. Just like in OFDM, guard intervals (called cyclic prefixes) with cyclic repetition are introduced between blocks of symbols in view to efficiently eliminate inter-symbol interference from time spreading (caused by multi-path propagation) among the blocks.

In SC-FDMA, multiple access among UEs is made possible by assigning different UEs different sets of non-overlapping Fourier coefficients (sub-carriers). This is achieved at the transmitter by inserting (prior to IDFT) silent Fourier coefficients (at positions assigned to other UEs), and removing them on the receiver side after the DFT.

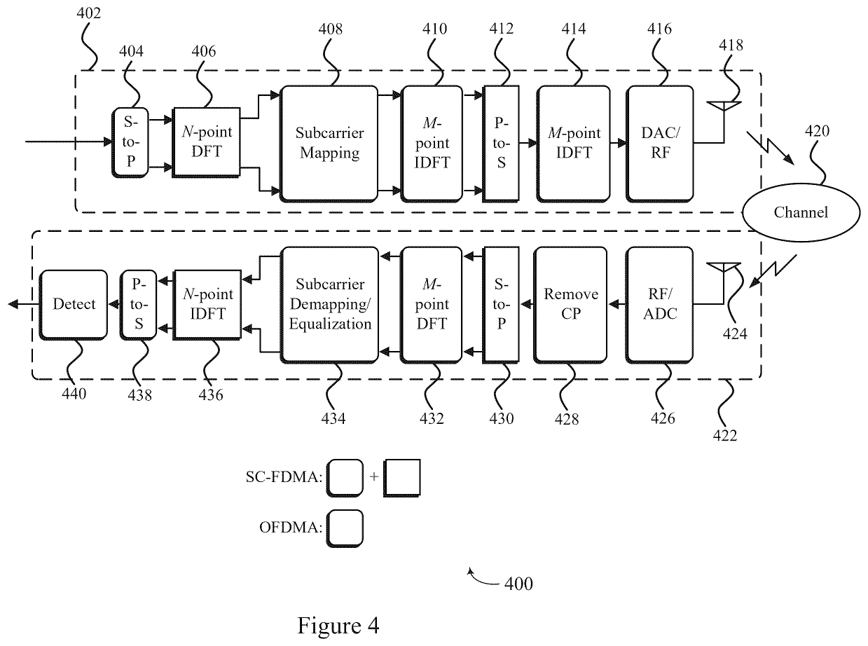

FIG. 4 illustrates an example 400 of SC-FDMA in accordance with aspects of the present disclosure. A transmitter 402 groups the modulation symbols into blocks each containing N symbols. The set of symbols are converted 404 from serial to parallel (S-to-P), and an N-point DFT 406 is performed to produce a frequency domain representation of the input symbols. Each of the N-DFT outputs is mapped 408 to one of the M (>N) orthogonal subcarriers that can be transmitted. An M-point IDFT 410 transforms the subcarrier amplitudes to a complex time domain signal, which is converted 412 from parallel to serial (P-to-S). The transmitter 402 also inserts a cyclic prefix (CP) in order and pulse shaping (PS) 414. A digital-to-analog converter (DAC) 416 converts the digital signal to a radio frequency (RF) signal which is transmitted by an antenna 418 over a channel 420 to a receiver 422.

An antenna 424 of the receiver 422 receives the signal over the channel 420. An analog-to-digital (ADC) converter 426 converts the received RF signal. CP is removed 428 and the signal is converted 430 from S-to-P. The received signal is transformed 432 into the frequency domain via DFT, the subcarriers are de-mapped and frequency domain equalization is performed 434. An N-point IDFT 436 is performed to produce the output symbols from the frequency domain, and the symbols are converted 438 from P-to-S and the individual symbols are detected 440.

Returning to FIG. 1, discussed herein are procedures for enabling SC-SCMA where multiple devices share the same single carrier frequency and are allocated different sparse codebooks that allow superposition of device transmissions and hence allow SCMA systems to support more connected ultra-low complexity and ultra-low power consumption devices with reduced PAPR levels. The multi-dimensional codewords of each UE can be spread over multiple symbols, time slots or frames. Each dimension of the multiple dimensions of a codeword is a portion (e.g., one bit) of the codeword. At the receiver, the received superposed signals can be detected using FDE (frequency domain equalizer) and a modified multi-UE detection architecture.

The methods described herein can be summarized as follows. Multiple UEs, associated with different sparse codebooks, can simultaneously transmit codewords over the same carrier frequency. In this case, the multi-dimensional codewords of each of the UEs are spread over multiple time symbols or time slots or a combination thereof. Each received symbol at the receiver is the superposition of multiple codewords' dimension and the receiver can use data from different symbols and/or slots for iterative detection to detect the UEs' data. The receiver architecture can be divided into two multi-UE detection blocks that allow the receiver to detect and decode each UE's signal. FDE is also used to overcome inter-symbol interference and inter-carrier interference.

The techniques discussed herein provide improved adaptability to low-complexity and low-power consumption devices (e.g., A-IoT devices) relative to conventional approaches. The techniques discussed herein also provide low PAPR and better overall system performance and energy efficiency relative to conventional approaches.

With respect to SC-SCMA, in one or more implementations more than two UEs can share the same, single carrier frequency at different time symbols or time slots in order to simultaneously transmit multi-dimensional codewords determined (e.g., drawn from, generated, selected) a sparse codebook allocated to each of the UEs. In this case, a single carrier scheme is used to multiplex UEs with different codebooks. The UEs' multiplexing or codeword spreading is performed in time domain instead of frequency domain. At the receiver, each received symbol represents the overlapping of multiple UEs' codewords' dimensions. For efficient and reliable detection, the receiver implements methods to identify each UEs' data superposed with other UEs over the same carrier frequency.

In SCMA, data is spread over multiple time-frequency resource units, for example tones of orthogonal frequency division multiple access (OFDMA) resources through multi-dimensional codewords. In other SCMA variants, the data may be spread over resource units of code division multiple access (CDMA), single carrier waveforms, filter bank multicarrier (FBMC), filtered OFDM, discrete Fourier transform spread OFDM (DFT spread OFDM), and the like.

Sparsity of codewords helps to reduce the complexity of joint detection of multiplexed SCMA layers by using MPA. In general, each layer of SCMA signal has its own specific codebook set.

In this disclosure, a network which is composed of several groups of UEs is studied. Every group consists of UEs with spatially correlated channels and proposed SCMA model analyses the performance of a single group with six UEs that have spatially correlated channels. It is to be appreciated that six UEs is an example and that a single group can have any number of multiple UEs (e.g., two or more UEs).

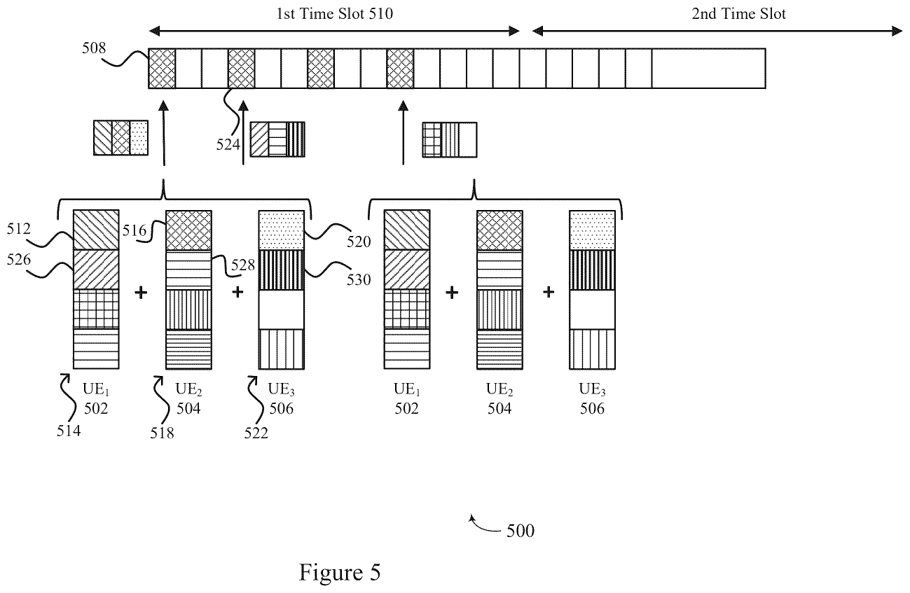

FIG. 5 illustrates an example 500 of SC-SCMA with UEs multiplexed on the same symbols in accordance with aspects of the present disclosure. In the example 500, the first UE can spread each of the sparse multi-dimensional codewords over the time symbols of one slot. The sparsity of the codeword enables the sharing of the same time slot between different non-overlapping UEs. The assignment of the symbols to each group of UEs can be, in one implementation, according to a pattern for example the same UEs can transmit over the first symbol and then choose to hop one or any fixed number of symbols x_{symb} and then spread the rest of the codeword.

As illustrated in the example 500, three UEs (UE 502, UE 504, and UE 506) have multi-dimensional (4-dimensional in example 500) codewords to communicate (e.g., transmit, send, output). In a first symbol 508 of a first time slot 510, the UE 502 communicates (e.g., transmits, sends, outputs) dimension 512 of codeword 514. Also in the first symbol 508 of the first time slot 510, the UE 504 communicates (e.g., transmits, sends, outputs) dimension 516 of codeword 518. Also in the first symbol 508 of the first time slot 510, the UE 506 communicates (e.g., transmits, sends, outputs) dimension 520 of codeword 522. In a second symbol 524 (after hopping over two symbols) of the first time slot 510, the UE 502 communicates (e.g., transmits, sends, outputs) dimension 526 of the codeword 514. Also in the second symbol 524 of the first time slot 510, the UE 504 communicates (e.g., transmits, sends, outputs) dimension 528 of the codeword 518. Also in the second symbol 524 of the first time slot 510, the UE 506 communicates (e.g., transmits, sends, outputs) dimension 530 of codeword 522. The UEs 502, 504, and 506 then communicates (e.g., transmits, sends, outputs) the remaining dimensions of the codewords 514, 518, and 522 on additional symbols of the first time slot 510.

Returning to FIG. 1, additionally or alternatively multiple UEs can use consecutive symbols of the same slot to spread the codewords. In this case, the number of consecutive symbols corresponds to the dimension of the codebooks.

Additionally or alternatively, the group of UEs sharing the same time-frequency resources can be configured to spread their codewords over different time slots. In this case, the first time slot can include a first subset of the symbols that correspond to the codewords, and the second time slot can include a second subset of the symbols that correspond to the codewords. For example, the first time slot could include symbols, e.g., symb₁, symb₂ and symb₃ that correspond to codewords of UEs (UE₁, UE₂, UE₃). The second multiplexing layer would correspond to symbols, e.g., symb₄ and symb₅ within the next time slot. In this case, each UEs' layer is associated with a different spreading sequence designed such that a number of UEs are multiplexed over the same symbols or slots.

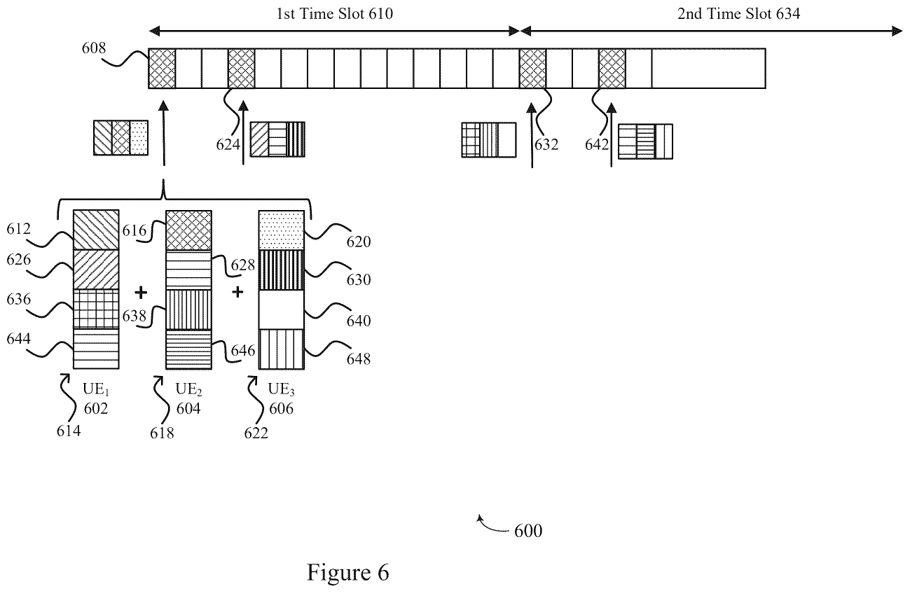

FIG. 6 illustrates an example 600 of SC-SCMA with UEs multiplexed on the same symbols in accordance with aspects of the present disclosure. In the example 600, three UEs (UE 602, UE 604, and UE 606) have multi-dimensional (4-dimensional in example 600) codewords to communicate (e.g., transmit, send, output). In a first symbol 608 of a first time slot 610, the UE 602 communicates (e.g., transmits, sends, outputs) dimension 612 of codeword 614. Also in the first symbol 608 of the first time slot 610, the UE 604 communicates (e.g., transmits, sends, outputs) dimension 616 of codeword 618. Also in the first symbol 608 of the first time slot 610, the UE 606 communicates (e.g., transmits, sends, outputs) dimension 620 of codeword 622. In a second symbol 624 (after hopping over two symbols) of the first time slot 610, the UE 602 communicates (e.g., transmits, sends, outputs) dimension 626 of the codeword 614. Also in the second symbol 624 of the first time slot 610, the UE 604 communicates (e.g., transmits, sends, outputs) dimension 628 of the codeword 618. Also in the second symbol 624 of the first time slot 610, the UE 606 communicates (e.g., transmits, sends, outputs) dimension 630 of codeword 622.

In a first symbol 632 of a second time slot 634, the UE 602 communicates (e.g., transmits, sends, outputs) dimension 636 of the codeword 614. Also in the first symbol 632 of the second time slot 634, the UE 604 communicates (e.g., transmits, sends, outputs) dimension 638 of the codeword 618. Also in the first symbol 632 of the second time slot 634, the UE 606 communicates (e.g., transmits, sends, outputs) dimension 640 of codeword 622. In a second symbol 642 (after hopping over two symbols) of the second time slot 634, the UE 602 communicates (e.g., transmits, sends, outputs) dimension 644 of the codeword 614. Also in the second symbol 642 of the second time slot 634, the UE 604 communicates (e.g., transmits, sends, outputs) dimension 646 of the codeword 618. Also in the second symbol 642 of the second time slot 634, the UE 606 communicates (e.g., transmits, sends, outputs) dimension 648 of codeword 622.

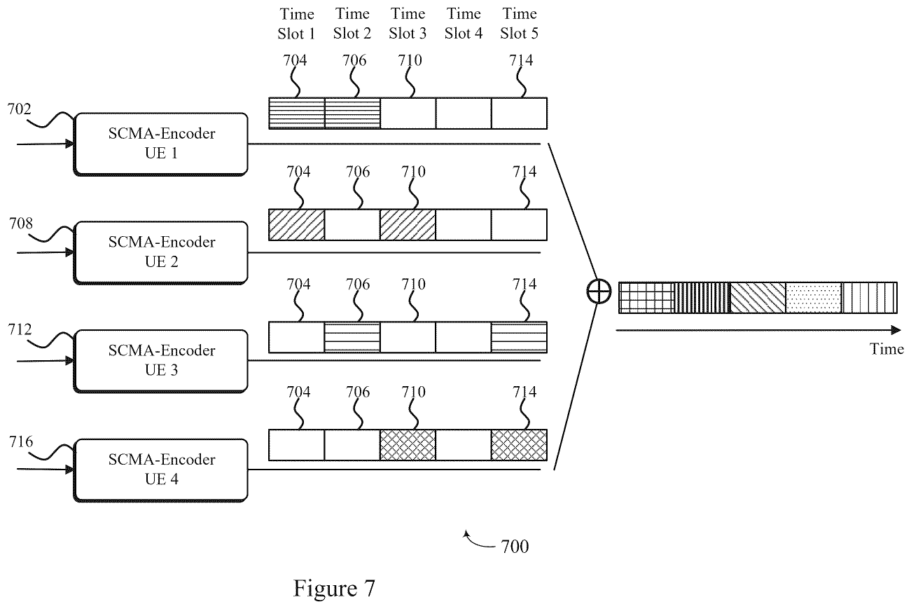

FIG. 7 illustrates an example 700 of SC-SCMA where UEs are allocated and multiplexed on the same slots in accordance with aspects of the present disclosure. In the example 700, each UE j can spread its multi-dimensional codewords over a dedicated time slot. In this case, time slots are shared between multiple UEs allowing an overloading factor greater than 1. In the example 700, a first UE 702 (UE 1) is allocated time slot 704 and time slot 706, a second UE 708 (UE 2) is allocated time slot 704 and time slot 710, a third UE 712 (UE 3) is allocated time slot 706 and time slot 714, and a fourth UE 716 (UE 4) is allocated time slot 710 and time slot 714.

The slots dedicated to a UE j can be contiguous as for UE 1 or non-contiguous as for UE 3. Each UE can be configured with a different spreading pattern. In this case, each resource element corresponds to a time slot so each SCMA symbol can be transmitted in Nc time slots. Therefore, total transmitted signal from UE u which consist of T_{c} SCMA symbols can be expressed as:

$${x}_{u} [ n ] = {\sum }_{k = 0}^{{T}_{c} - 1} {c}_{{𝒞}_{u}}^{( u )} [ n - k {N}_{c} ]$$

where N_{c} corresponds to the number of resource elements and [symbol] is the multi-dimensional codeword of UE u. The superposed signal at the receiver can be expressed as follows:

$$r [ n ] = {\sum }_{u = 1}^{K} {h}_{u} {x}_{u} [ n ] + n [ n ]$$

where hᵤ are Rayleigh channel coefficients for UEs u and n[n] is the noise figure in the channel.

Additionally or alternatively, dynamic slot allocation can be performed. In this case, contiguous slots can be allocated to UEs' (UEs) signals, at each slot the UEs simultaneously communicate (e.g., transmit, send, output) their data. The received signals consist of superposed UEs' codewords spread over multiple slots. Additionally or alternatively, the slots allocated to a group of UEs can be non-contiguous. In this case, the slots can be configured to be within the same frame time in order to allow the detection and decoding of the received superposed symbols.

Additionally or alternatively, the multiple UEs' signals can be associated with different transmitting powers besides being spread over different time slots. In this case, UEs within the same group can be associated with a power Pᵢ where i is the group number and each of the UEs can be assigned with a different codebook [symbol] , where u is the UE number.

Returning to FIG. 1, the techniques discussed herein enable the implementation of SCMA with reduced PAPR which is beneficial for the overall network performance and energy-efficiency. The scheme is also beneficial for ultra-low complexity and ultra-low power consumption devices such as A-IoT devices that cannot support multi-carrier waveforms.

With respect to SC-SCMA and multi-UE MIMO (MU-MIMO) systems, in one or more implementations the SC-SCMA scheme can be merged with a MIMO system which allows higher multiplexing diversity. In one example, the number of transmit and receive antennas (Nₜ, Nᵣ) can be equal to (or possibly greater than) the number of time resources allocated to each of the UEs. In this case, the multiplexing of UEs can be performed in both time and spatial domains. This enables the less complex identification of UEs at the receiver. In another example, the number of antennas (Nₜ, Nᵣ) can be smaller than the number of dedicated resources per UE. In this case, spatial multiplexing would impact some special resources.

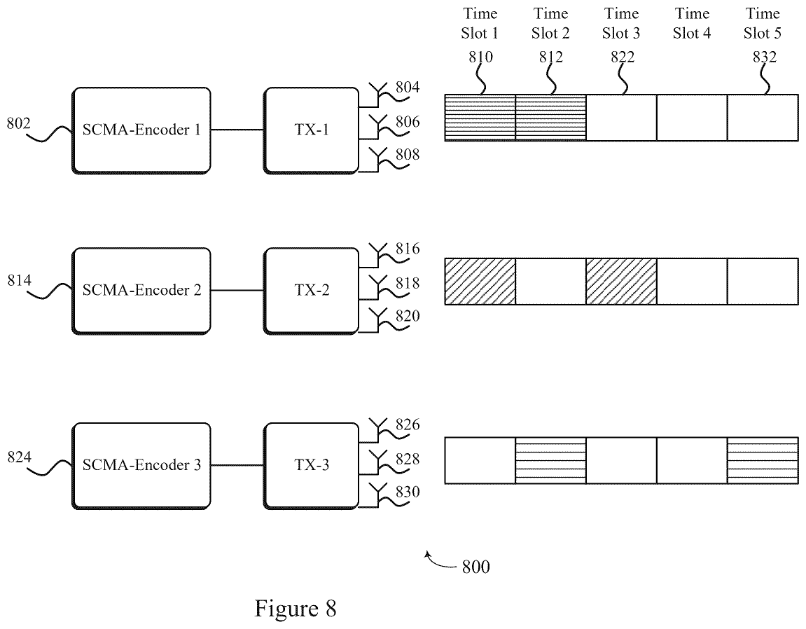

FIG. 8 illustrates an example of SC-SCMA combined with MU-MIMO in accordance with aspects of the present disclosure. In the example 800, a first UE having a first SCMA encoder 802 has three transmit (TX) antennas 804, 806, and 808, and is allocated time slot 810 and time slot 812. A second UE having a second SCMA encoder 814 has three TX antennas 816, 818, and 820, and is allocated time slot 810 and time slot 822. A third UE having a third SCMA encoder 824 has three TX antennas 826, 828, and 830, and is allocated time slot 812 and time slot 832.

Returning to FIG. 1, with respect to a receiver architecture for SC-SCMA, in one or more implementations a single carrier FDE can be used at the receiver prior to the multi-UE detection scheme. The FDE enables the suppression of the inter-symbol interference and inter-carrier interference when the signal traverses a frequency selective channel. An iterative decision feedback system architecture is designed with parallel factor graphs which has similar complexity with conventional receivers and use outputs of the bank of match filters can be implemented at the receiver side.

In this case, each group of UEs are associated with a common factor graph which detects each UE's data. The output of the common factor graph is then fed to UE-specific factor graph, which identifies the UE codewords. Although a factor graph based detector is discussed herein as associating a multi-dimensional sparse codeword with a UE, it is to be appreciated that other types of detectors or classification systems can additionally or alternatively be used, such as other types of probabilistic models, trained machine learning models, and so forth.

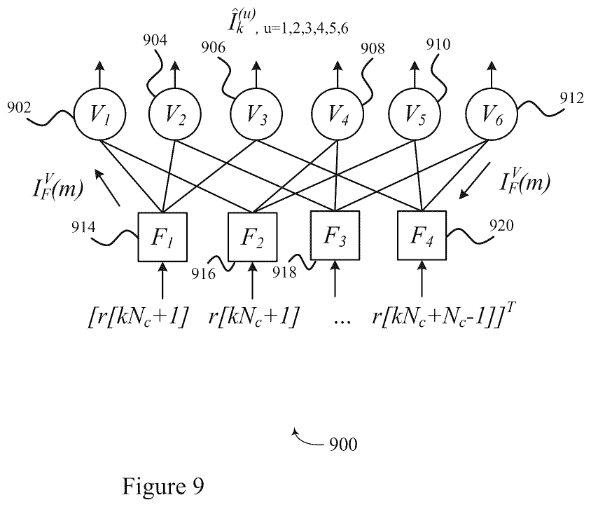

FIG. 9 illustrates an example of a factor graph 900 associated with SC-SCMA in accordance with aspects of the present disclosure. The factor graph 900 is a common factor graph representation associated with six UEs 902, 904, 906, 908, 910, and 912, and four time resources 914, 916, 918, 920. Each received symbol can be presented as follows:

$$r [ n ] = {\sum }_{u = 1}^{K} {h}_{u} {x}_{u} [ n ] + n [ n ]$$

where hᵤ are Rayleigh channel coefficients, xᵤ are UE's symbols and n is an additive white Gaussian noise with variance σ² and K is the number of UEs superposed over the considered symbol. After performing an FDE and FFT, the resultant symbol is represented as [r[kN_{c}+1] r[kN_{c}+1] . . . r[kN_{c}+N_{c}−1]]^{T}, where Ne corresponds to the number of resource elements for UEs k.

The receiver, after performing an FDE, performs iterative detection over the received symbol to identify each of the UE's data. This iterative detection can include, for example, an MPA or an AMP algorithm. Although MPA and AMP algorithms are discussed herein, it is to be appreciated that the iterative detection can be performed using other algorithms. The output, which can be for example extrinsic information such as LLRs, is then fed to another factor graph based iterative decoder associated with each UE to detect and decode the UE's codewords.

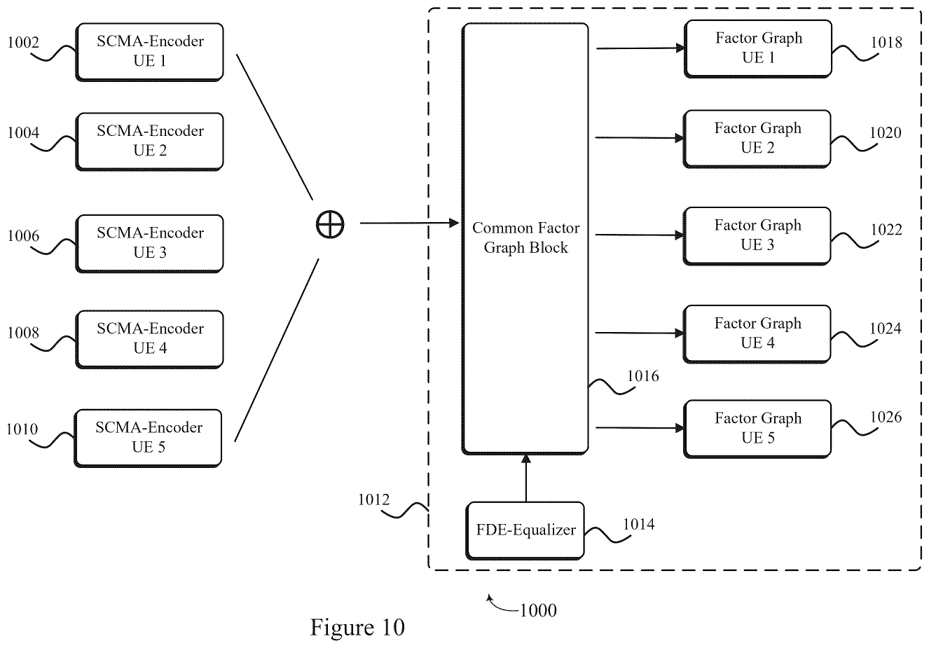

FIG. 10 illustrates an example receiver architecture 1000 associated with SC-SCMA in accordance with aspects of the present disclosure. The receiver architecture 1000 can be implemented in, for example, an NE 102 of FIG. 1. In the example of FIG. 10, UEs of five different UEs 1002, 1004, 1006, 1008, and 1010 each communicate (e.g., transmit, send, output), over a single carrier frequency, a symbol that is part of a different multi-dimensional sparse codeword. The symbols are received by a receiver 1012 where an FDE-equalizer 1014 performs FDE on the received symbol. After performing FDE, a common factor graph block 1016 performs iterative detection over the received symbol to identify each of the UE's data. For each of the UE's data, the output of the common factor graph block 1016 is input to a UE-specific factor graph to detect and decode the UE's codewords. As illustrated factor graph 1018 is associated with UE 1002, factor graph 1020 is associated with UE 1004, factor graph 1022 is associated with UE 1006, factor graph 1024 is associated with UE 1008, and factor graph 1026 is associated with UE 1010.

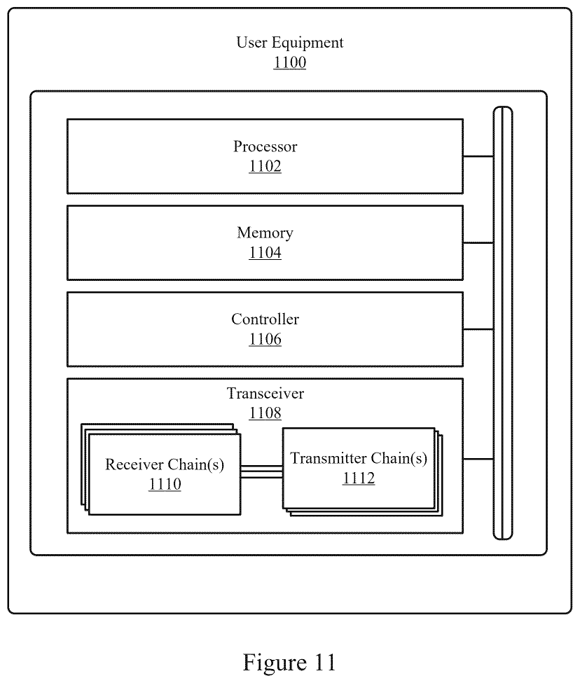

FIG. 11 illustrates an example of a UE 1100 in accordance with aspects of the present disclosure. The UE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the UE 1100 to perform various functions of the present disclosure.

The memory 1104 may include volatile or non-volatile memory. The memory 1104 may store computer-readable, computer-executable code including instructions when executed by the processor 1102 cause the UE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the UE 1100 to perform one or more of the functions described herein (e.g., executing, by the processor 1102, instructions stored in the memory 1104). For example, the processor 1102 may support wireless communication at the UE 1100 in accordance with examples as disclosed herein. The UE 1100 may be configured to or operable to support a means for receiving a configuration for the UE to transmit a first multi-dimensional sparse codeword across a set of multiple time units over a single carrier frequency; transmitting the first multi-dimensional sparse codeword across the set of multiple time units over the single carrier frequency.

Additionally, the UE 1100 may be configured to support any one or combination of where the set of multiple time units is available to at least one additional UE for transmission; where the set of multiple time units comprises a set of multiple symbols, a set of multiple time slots, a set of multiple subframes, a set of multiple frames, or a combination thereof; where the first multi-dimensional sparse codeword is determined from a first sparse codebook; where the set of multiple time units are contiguous; where the set of multiple time units are non-contiguous; where the configuration indicates a first antenna of multiple antennas the UE is to use to transmit the first multi-dimensional sparse codeword.

Additionally, or alternatively, the UE 1100 may support at least one memory (e.g., the memory 1104) and at least one processor (e.g., the processor 1102) coupled with the at least one memory and configured to cause the UE to: receive a configuration for the UE to transmit a first multi-dimensional sparse codeword across a set of multiple time units over a single carrier frequency; transmit the first multi-dimensional sparse codeword across the set of multiple time units over the single carrier frequency.

Additionally, the UE 1100 may be configured to support any one or combination of the at least one processor is configured to where the set of multiple time units is available to at least one additional UE for transmission; where the set of multiple time units comprises a set of multiple symbols, a set of multiple time slots, a set of multiple subframes, a set of multiple frames, or a combination thereof; where the first multi-dimensional sparse codeword is determined from a first sparse codebook; where the set of multiple time units are contiguous; where the set of multiple time units are non-contiguous; where the configuration indicates a first antenna of multiple antennas the UE is to use to transmit the first multi-dimensional sparse codeword.

The controller 1106 may manage input and output signals for the UE 1100. The controller 1106 may also manage peripherals not integrated into the UE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the UE 1100 may include at least one transceiver 1108. In some other implementations, the UE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

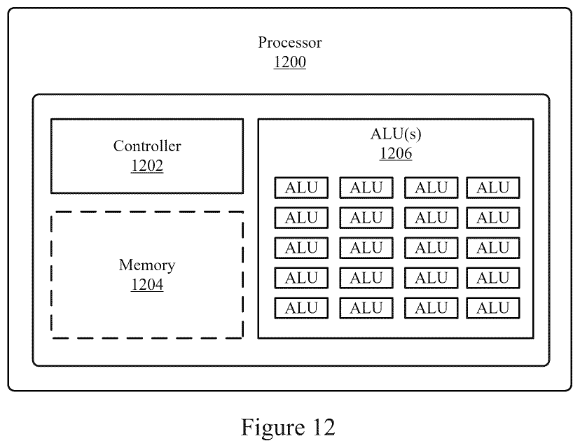

FIG. 12 illustrates an example of a processor 1200 in accordance with aspects of the present disclosure. The processor 1200 may be an example of a processor configured to perform various operations in accordance with examples as described herein. The processor 1200 may include a controller 1202 configured to perform various operations in accordance with examples as described herein. The processor 1200 may optionally include at least one memory 1204, which may be, for example, an L1/L2/L3 cache. Additionally, or alternatively, the processor 1200 may optionally include one or more arithmetic-logic units (ALUs) 1206. One or more of these components may be in electronic communication or otherwise coupled (e.g., operatively, communicatively, functionally, electronically, electrically) via one or more interfaces (e.g., buses).

The processor 1200 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1200) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1202 may be configured to manage and coordinate various operations (e.g., signaling, receiving, obtaining, retrieving, transmitting, outputting, forwarding, storing, determining, identifying, accessing, writing, reading) of the processor 1200 to cause the processor 1200 to support various operations in accordance with examples as described herein. For example, the controller 1202 may operate as a control unit of the processor 1200, generating control signals that manage the operation of various components of the processor 1200. These control signals include enabling or disabling functional units, selecting data paths, initiating memory access, and coordinating timing of operations.

The controller 1202 may be configured to fetch (e.g., obtain, retrieve, receive) instructions from the memory 1204 and determine subsequent instruction(s) to be executed to cause the processor 1200 to support various operations in accordance with examples as described herein. The controller 1202 may be configured to track memory addresses of instructions associated with the memory 1204. The controller 1202 may be configured to decode instructions to determine the operation to be performed and the operands involved. For example, the controller 1202 may be configured to interpret the instruction and determine control signals to be output to other components of the processor 1200 to cause the processor 1200 to support various operations in accordance with examples as described herein. Additionally, or alternatively, the controller 1202 may be configured to manage flow of data within the processor 1200. The controller 1202 may be configured to control transfer of data between registers, ALUs 1206, and other functional units of the processor 1200.

The memory 1204 may include one or more caches (e.g., memory local to or included in the processor 1200 or other memory, such as RAM, ROM, DRAM, SDRAM, SRAM, MRAM, flash memory, etc. In some implementations, the memory 1204 may reside within or on a processor chipset (e.g., local to the processor 1200). In some other implementations, the memory 1204 may reside external to the processor chipset (e.g., remote to the processor 1200).

The memory 1204 may store computer-readable, computer-executable code including instructions that, when executed by the processor 1200, cause the processor 1200 to perform various functions described herein. The code may be stored in a non-transitory computer-readable medium such as system memory or another type of memory. The controller 1202 and/or the processor 1200 may be configured to execute computer-readable instructions stored in the memory 1204 to cause the processor 1200 to perform various functions. For example, the processor 1200 and/or the controller 1202 may be coupled with or to the memory 1204, the processor 1200, and the controller 1202, and may be configured to perform various functions described herein. In some examples, the processor 1200 may include multiple processors and the memory 1204 may include multiple memories. One or more of the multiple processors may be coupled with one or more of the multiple memories, which may, individually or collectively, be configured to perform various functions herein.

The one or more ALUs 1206 may be configured to support various operations in accordance with examples as described herein. In some implementations, the one or more ALUs 1206 may reside within or on a processor chipset (e.g., the processor 1200). In some other implementations, the one or more ALUs 1206 may reside external to the processor chipset (e.g., the processor 1200). One or more ALUs 1206 may perform one or more computations such as addition, subtraction, multiplication, and division on data. For example, one or more ALUs 1206 may receive input operands and an operation code, which determines an operation to be executed. One or more ALUs 1206 may be configured with a variety of logical and arithmetic circuits, including adders, subtractors, shifters, and logic gates, to process and manipulate the data according to the operation. Additionally, or alternatively, the one or more ALUs 1206 may support logical operations such as AND, OR, exclusive-OR (XOR), not-OR (NOR), and not-AND (NAND), enabling the one or more ALUs 1206 to handle conditional operations, comparisons, and bitwise operations.

The processor 1200 may support wireless communication in accordance with examples as disclosed herein. The processor 1200 may be configured to or operable to support at least one controller (e.g., the controller 1202) coupled with at least one memory (e.g., the memory 1204) and configured to cause the processor to: receive a configuration for the processor to transmit a first multi-dimensional sparse codeword across a set of multiple time units over a single carrier frequency; transmit the first multi-dimensional sparse codeword across the set of multiple time units over the single carrier frequency.

Additionally, the processor 1200 may be configured to or operable to support any one or combination of the at least one controller is configured to cause the processor to where the set of multiple time units is available to at least one additional processor for transmission; where the first multi-dimensional sparse codeword is determined from a first sparse codebook; where the set of multiple time units comprises a set of multiple symbols, a set of multiple time slots, a set of multiple subframes, a set of multiple frames, or a combination thereof; where the set of multiple time units are contiguous; where the set of multiple time units are non-contiguous; where the configuration indicates a first antenna of multiple antennas the processor is to use to transmit the first multi-dimensional sparse codeword.

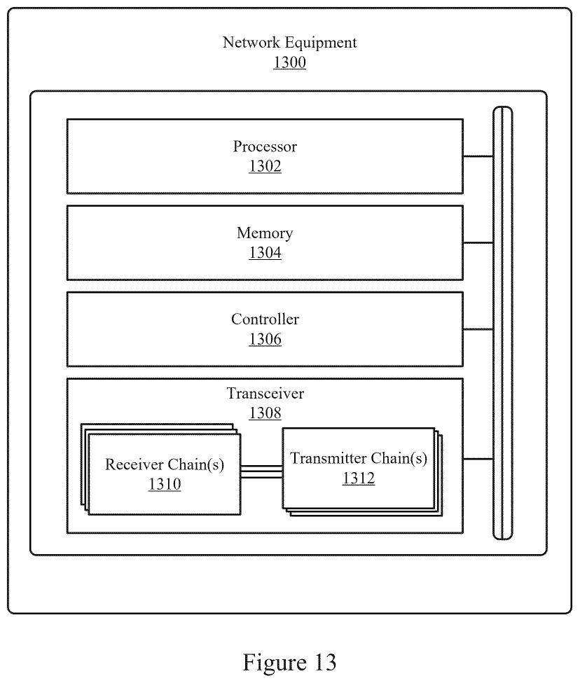

FIG. 13 illustrates an example of a NE 1300 in accordance with aspects of the present disclosure. The NE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the NE 1300 to perform various functions of the present disclosure.

The memory 1304 may include volatile or non-volatile memory. The memory 1304 may store computer-readable, computer-executable code including instructions when executed by the processor 1302 cause the NE 1300 to perform various functions described herein. The code may be stored in a non-transitory computer-readable medium such as the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the NE 1300 to perform one or more of the functions described herein (e.g., executing, by the processor 1302, instructions stored in the memory 1304). For example, the processor 1302 may support wireless communication at the NE 1300 in accordance with examples as disclosed herein. The NE 1300 may be configured to support a means for transmitting a first configuration for a first UE to transmit a first multi-dimensional sparse codeword across a set of multiple time units over a single carrier frequency; transmitting a second configuration for a second UE to transmit a second multi-dimensional sparse codeword across the set of multiple time units over the single carrier frequency; and transmitting a second configuration for a second UE to transmit a second multi-dimensional sparse codeword across the set of multiple time units over the single carrier frequency.

Additionally, the NE 1300 may be configured to support any one or combination of where the set of multiple time units comprises a set of multiple symbols, a set of multiple time slots, a set of multiple subframes, a set of multiple frames, or a combination thereof; where the first multi-dimensional sparse codeword is determined from a first sparse codebook, where the second multi-dimensional sparse codeword is determined from a second sparse codebook, and where the first sparse codebook is different than the second sparse codebook; where the set of multiple time units allocated to the first UE are contiguous; where the set of multiple time units allocated to the first UE are non-contiguous; where the first configuration indicates a first antenna of multiple antennas the first UE is to use to transmit the first multi-dimensional sparse codeword, and where the second configuration indicates a second antenna of multiple antennas the second UE is to use to transmit the second multi-dimensional sparse codeword; associating, using a detector and a FDE, the first multi-dimensional sparse codeword with the first UE; and associating, using the detector and the FDE, the second multi-dimensional sparse codeword with the second UE; where the detector comprises a common factor graph based multi-UE detector and a parallel UE-specific factor graph-based detector; where the detector comprises a MPA or an AMP algorithm; where the detector comprises an iterative detection algorithm.

Additionally, or alternatively, the NE 1300 may support at least one memory (e.g., the memory 1304) and at least one processor (e.g., the processor 1302) coupled with the at least one memory and configured to cause the NE to: transmit a first configuration for a first UE to transmit a first multi-dimensional sparse codeword across a set of multiple time units over a single carrier frequency; transmit a second configuration for a second UE to transmit a second multi-dimensional sparse codeword across the set of multiple time units over the single carrier frequency; receive, simultaneously, the first multi-dimensional sparse codeword and the second multi-dimensional sparse codeword across the set of multiple time units over the single carrier frequency.

Additionally, the NE 1300 may be configured to support any one or combination of the at least one processor is configured to cause the NE to where the set of multiple time units comprises a set of multiple symbols, a set of multiple time slots, a set of multiple subframes, a set of multiple frames, or a combination thereof; where the first multi-dimensional sparse codeword is determined from a first sparse codebook, where the second multi-dimensional sparse codeword is determined from a second sparse codebook, and where the first sparse codebook is different than the second sparse codebook; where the set of multiple time units allocated to the first UE are contiguous; where the set of multiple time units allocated to the first UE are non-contiguous; where the first configuration indicates a first antenna of multiple antennas the first UE is to use to transmit the first multi-dimensional sparse codeword, and where the second configuration indicates a second antenna of multiple antennas the second UE is to use to transmit the second multi-dimensional sparse codeword; associate, using a detector and a FDE, the first multi-dimensional sparse codeword with the first UE; and associate, using the detector and the FDE, the second multi-dimensional sparse codeword with the second UE; where the detector comprises a common factor graph based multi-UE detector and a parallel UE-specific factor graph-based detector; where the detector comprises a MPA or an AMP algorithm; where the detector comprises an iterative detection algorithm.

The controller 1306 may manage input and output signals for the NE 1300. The controller 1306 may also manage peripherals not integrated into the NE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the NE 1300 may include at least one transceiver 1308. In some other implementations, the NE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas to receive a signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

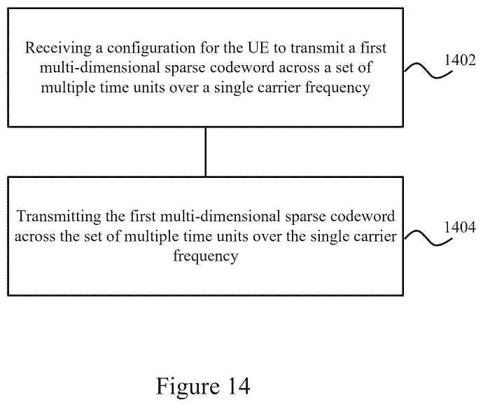

FIG. 14 illustrates a flowchart of a method in accordance with aspects of the present disclosure. The operations of the method may be implemented by a UE as described herein. In some implementations, the UE may execute a set of instructions to control the function elements of the UE to perform the described functions.

At 1402, the method may include receiving a configuration for the UE to transmit a first multi-dimensional sparse codeword across a set of multiple time units over a single carrier frequency. The operations of 1402 may be performed in accordance with examples as described herein. In some implementations, aspects of the operations of 1402 may be performed by a UE as described with reference to FIG. 11.

At 1404, the method may include transmitting the first multi-dimensional sparse codeword across the set of multiple time units over the single carrier frequency. The operations of 1404 may be performed in accordance with examples as described herein. In some implementations, aspects of the operations of 1404 may be performed by a UE as described with reference to FIG. 11.

It should be noted that the method described herein describes a possible implementation, and that the operations and the steps may be rearranged or otherwise modified and that other implementations are possible.

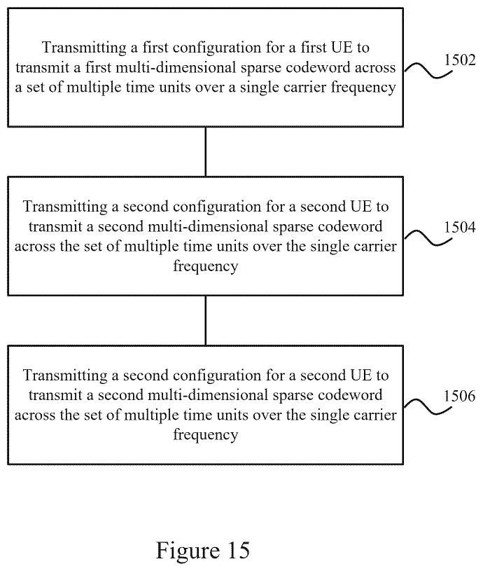

FIG. 15 illustrates a flowchart of a method in accordance with aspects of the present disclosure. The operations of the method may be implemented by a NE as described herein. In some implementations, the NE may execute a set of instructions to control the function elements of the NE to perform the described functions.

At 1502, the method may include transmitting a first configuration for a first UE to transmit a first multi-dimensional sparse codeword across a set of multiple time units over a single carrier frequency. The operations of 1502 may be performed in accordance with examples as described herein. In some implementations, aspects of the operations of 1502 may be performed by a NE as described with reference to FIG. 13.

At 1504, the method may include transmitting a second configuration for a second UE to transmit a second multi-dimensional sparse codeword across the set of multiple time units over the single carrier frequency. The operations of 1504 may be performed in accordance with examples as described herein. In some implementations, aspects of the operations of 1504 may be performed by a NE as described with reference to FIG. 13.

At 1506, the method may include transmitting a second configuration for a second UE to transmit a second multi-dimensional sparse codeword across the set of multiple time units over the single carrier frequency. The operations of 1506 may be performed in accordance with examples as described herein. In some implementations, aspects of the operations of 1506 may be performed a NE as described with reference to FIG. 13.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a configuration for the UE to transmit a first multi-dimensional sparse codeword across a set of multiple time units over a single carrier frequency; and
transmit the first multi-dimensional sparse codeword across the set of multiple time units over the single carrier frequency.

2. The UE of claim 1, wherein the set of multiple time units comprises a set of multiple symbols, a set of multiple time slots, a set of multiple subframes, a set of multiple frames, or a combination thereof.

3. The UE of claim 1, wherein the first multi-dimensional sparse codeword is determined from a first sparse codebook.

4. The UE of claim 1, wherein the set of multiple time units are contiguous.

5. The UE of claim 1, wherein the set of multiple time units are non-contiguous.

6. The UE of claim 1, wherein the configuration indicates a first antenna of multiple antennas the UE is to use to transmit the first multi-dimensional sparse codeword.

7. A base station for wireless communication, comprising:
at least one memory; and
at least one processor coupled with the at least one memory and configured to cause the base station to:
transmit a first configuration for a first user equipment (UE) to transmit a first multi-dimensional sparse codeword across a set of multiple time units over a single carrier frequency;
transmit a second configuration for a second UE to transmit a second multi-dimensional sparse codeword across the set of multiple time units over the single carrier frequency;
receive, simultaneously, the first multi-dimensional sparse codeword and the second multi-dimensional sparse codeword across the set of multiple time units over the single carrier frequency.

8. The base station of claim 7, wherein the set of multiple time units comprises a set of multiple symbols, a set of multiple time slots, a set of multiple subframes, a set of multiple frames, or a combination thereof.

9. The base station of claim 7, wherein the first multi-dimensional sparse codeword is determined from a first sparse codebook, wherein the second multi-dimensional sparse codeword is determined from a second sparse codebook, and wherein the first sparse codebook is different than the second sparse codebook.

10. The base station of claim 7, wherein the set of multiple time units allocated to the first UE are contiguous.

11. The base station of claim 7, wherein the set of multiple time units allocated to the first UE are non-contiguous.

12. The base station of claim 7, wherein the first configuration indicates a first antenna of multiple antennas the first UE is to use to transmit the first multi-dimensional sparse codeword, and wherein the second configuration indicates a second antenna of multiple antennas the second UE is to use to transmit the second multi-dimensional sparse codeword.

13. The base station of claim 7, wherein the at least one processor is further configured to cause the base station to:
associate, using a detector and a frequency domain equalizer (FDE), the first multi-dimensional sparse codeword with the first UE; and
associate, using the detector and the FDE, the second multi-dimensional sparse codeword with the second UE.

14. The base station of claim 13, wherein the detector comprises a common factor graph based multi-UE detector and a parallel UE-specific factor graph-based detector.

15. The base station of claim 13, wherein the detector comprises an iterative detection algorithm.

16. A processor for wireless communication, comprising:
at least one controller coupled with at least one memory and configured to cause the processor to:
receive a configuration for the processor to transmit a first multi-dimensional sparse codeword across a set of multiple time units over a single carrier frequency;
transmit the first multi-dimensional sparse codeword across the set of multiple time units over the single carrier frequency.

17. The processor of claim 16, wherein the set of multiple time units is available to at least one additional processor for transmission.

18. The processor of claim 16, wherein the first multi-dimensional sparse codeword is determined from a first sparse codebook.

19. A method performed by a base station, the method comprising:
transmitting a first configuration for a first user equipment (UE) to transmit a first multi-dimensional sparse codeword across a set of multiple time units over a single carrier frequency;
transmitting a second configuration for a second UE to transmit a second multi-dimensional sparse codeword across the set of multiple time units over the single carrier frequency; and
transmitting a second configuration for a second UE to transmit a second multi-dimensional sparse codeword across the set of multiple time units over the single carrier frequency.

20. The method of claim 19, wherein the set of multiple time units comprises a set of multiple symbols, a set of multiple time slots, a set of multiple subframes, a set of multiple frames, or a combination thereof.
